(19) United States
(12) Patent Application Publication
(10) Pub. No.: US 2004/0212533 A1
(43) Pub. Date: Oct. 28, 2004

(54) Method and system for satellite based phase measurements for relative positioning of fixed or slow moving points in close proximity

(76) Inventors: Michael L. Whitehead, Scottsdale, AZ (US); Walter Feller, Airdrie (CA)

Correspondence Address: CANTOR COLBURN LLP, 55 Griffin Road South, Bloomfield, CT, 06002, US

(21) Appl. No.: 10/828,745

(22) Filed: Apr. 21, 2004

Related U.S. Application Data
(60) Provisional application No. 60/464,756, filed on Apr. 23, 2003.

(51) Int. Cl. G01S 5/14

(52) U.S. Cl. 342/357.08

(57) ABSTRACT

A method for measuring relative position of fixed or slow-moving points in close proximity comprising: receiving a set of satellite signals with a first receiver corresponding to a first position; receiving a related set of satellite signals with a second receiver corresponding to a second position; and computing a position of the second position based on at least one of code phase and carrier phase differencing techniques. At least one of: a clock used in the first receiver and a clock used in the second receiver are synchronized to eliminate clock variation between the first receiver and the second receiver; and the first receiver and the second receiver share a common clock.

### CROSS-REFERENCE TO RELATED APPLICATIONS

This application claims the benefit of U.S. Provisional Application No. 60/464,756, filed Apr. 23, 2003 the contents of which are incorporated by reference herein in their entirety.

### BACKGROUND OF THE INVENTION

The invention relates generally to Global Positioning System (GPS) receivers and more particularly to a method and an apparatus for computing multiple precise locations using differential carrier phases of a GPS satellite signal by synchronizing the clocks between the master receiver and the slave receiver. It further describes a technique of connecting a plurality of antennas to the slave receiver, which can be switched in to measure each antennas relative location to the master antenna for monitoring long-term deformation.

### GPS Background

The Global Positioning System (GPS) was established by the United States government, and employs a constellation of 24 or more satellites in well-defined orbits at an altitude of approximately 26,500 km. These satellites continually transmit microwave L-band radio signals in two frequency bands, centered at 1575.42 MHz and 1227.6 MHz., denoted as L1 and L2 respectively. These signals include timing patterns relative to the satellite's onboard precision clock (which is kept synchronized by a ground station) as well as a navigation message giving the precise orbital positions of the satellites. GPS receivers process the radio signals, computing ranges to the GPS satellites and by triangulating these ranges; the GPS receiver determines its position and its internal clock error. Different levels of accuracies can be achieved depending on the techniques deployed. This invention specifically targets the sub-centimeter accuracies achievable on a remote and possibly mobile GPS receiver by processing carrier phase observations both from the remote receiver and from one or more fixed-position reference stations. This procedure is often referred to as Real Time Kinematic or RTK.

To gain a better understanding of the accuracy levels achievable by using the GPS system, it is necessary understand the two types of signals available from the GPS satellites. The first type of signal includes both the Coarse Acquisition (C/A), which modulates the L1 radio signal and precision (P) code, which modulates both the L1 and L2 radio signals. These are pseudorandom digital codes that provide a known pattern that can be compared to the receiver's version of that pattern. By measuring the time-shift required to align the pseudorandom digital codes, the GPS receiver is able to compute an unambiguous pseudo-range to the satellite. Both the C/A and P codes have a relatively long “wavelength,” of about 300 meters (1 microsecond) and 30 meters (1/10 microsecond), respectively. Consequently, use of the C/A code and the P code yield position data only at a relatively coarse level of resolution.

The second type of signal utilized for position determination is the carrier signals. The term “carrier”, as used herein, refers to the dominant spectral component which remains in the radio signal after the spectral content caused by the modulated pseudorandom digital codes (C/A and P) is removed. The L1 and L2 carrier signals have wavelengths of about 19 and 24 centimeters, respectively. The GPS receiver is able to “track” these carrier signals, and in doing so, make measurements of the carrier phase to a small fraction of a complete wavelength, permitting range measurement to an accuracy of less than a centimeter.

In stand-alone GPS systems that determine a receiver's position coordinates without reference to a nearby reference receiver, the process of position determination is subject to errors from a number of sources. These include errors in the satellite's clock reference, the location of the orbiting satellite, ionospheric refraction errors (which delay GPS code signals but advance GPS carrier signals), and tropospheric induced delay errors. Prior to May 2, 2002, a large portion of the satellite's clock error, referred to as Selective Availability (SA) was purposefully induced by the U.S. Department of Defense to limit GPS accuracy to non-authorized users. SA would often cause positioning errors exceeding 40 meters, but even today, with SA off, errors caused by the ionosphere can be tens of meters. The above mentioned error sources (satellite clock and satellite position errors, ionosphere refraction, tropospheric delay and SA) are common-mode errors for two receivers that are nearby. That is, the errors caused by these sources are nearly the same for each receiver

Another error source, which is present in the carrier phase measurements, is the clock differences between the two receivers. This clock difference applies to all satellite measurements equally, and as such, can be eliminated by what is known as double differencing. This is where one of the satellites is used as a reference and the other satellite measurements are compared to it. This reduces the number of usable satellite measurements by one. As will be explained later, the more measurements available the better the final solution.

To overcome the common-mode errors of the stand-alone GPS system, many kinematic positioning applications make use of multiple GPS receivers. A reference receiver located at a reference site having known coordinates receives the satellite signals simultaneously with the receipt of signals by a remote receiver. Depending on the separation distance, the common-modethe errors mentioned above will affect the satellite signals equally for the two receivers. By taking the difference between signals received both at the reference site and at the remote location, common-mode errors are effectively eliminated. This facilitates an accurate determination of the remote receiver's coordinates relative to the reference receiver's coordinates.

The technique of differencing signals is known in the art as differential GPS (DGPS). The combination of DGPS with precise measurements of carrier phase leads to position accuracies of less than one centimeter root-mean-squared (centimeter-level positioning). When DGPS positioning utilizing carrier phase is done in real-time while the remote receiver is potentially in motion, it is often referred to as Real-Time Kinematic (RTK) positioning.

One of the difficulties in performing RTK positioning using carrier signals is the existence of an inherent ambiguity that arises because each cycle of the carrier signal looks exactly alike. Therefore, the range measurement based upon carrier phase has an ambiguity equivalent to an integral number of carrier signal wavelengths. Various techniques are used to resolve the ambiguity, which usually involves some form of double-differencing of the carrier measurements. Once ambiguities are solved, however, the receiver continues to apply a constant ambiguity correction to a carrier measurement until loss of lock on that carrier signal or partial loss of lock that results in a carrier cycle slip.

Regardless of the technique deployed, the problem of solving integer ambiguities, in real-time, is always faster and more robust if there are more measurements upon which to discriminate the true integer ambiguities. Robust means that there is less chance of choosing an incorrect set of ambiguities. The degree to which the carrier measurements collectively agree to a common location of the GPS receiver is used as a discriminator in choosing the correct set of ambiguities. The more carrier phase measurements that are available, the more likely it is that the best measure of agreement will correspond to the true (relative to the reference GPS) position of the remote GPS receiver. One method, which effectively gives more measurements, is to use carrier phase measurements on both L1 and L2. The problem though is that it is relatively difficult to track L2 because it is modulated only by P code and United States Department of Defense has limited access to P code modulation by encrypting the P code prior to transmission. Some receivers are capable of applying various cross-correlation techniques to track the P code on L2, but these are usually more expensive receivers that L1 only capable receivers.

Other approaches have been employed to gain additional measurements on GPS receivers utilizing additional satellites and other types of satellite systems such as the GLONASS system, pseudolites, or Low Earth Orbit (LEO) satellite signals in an attempt to enhance RTK. Nevertheless, it is often desired to perform RTK on low-cost L1 only receivers that do not have access to the GLONASS system, pseudolites, or LEO satellite signals.

### SUMMARY OF THE INVENTION

Disclosed herein in an exemplary embodiment is a method for measuring relative position of fixed or slow-moving points in close proximity comprising: receiving a set of satellite signals with a first receiver corresponding to a first position; receiving a related set of satellite signals with a second receiver corresponding to a second position; and computing a position of the second position based on at least one of code phase and carrier phase differencing techniques. At least one of: a clock used in the first receiver and a clock used in the second receiver are synchronized to eliminate substantial clock variation between the first receiver and the second receiver; and the first receiver and the second receiver share a common clock.

Also disclosed herein in another exemplary embodiment is a system for measuring relative position of fixed or slow-moving points in close proximity comprising: a first receiver in operable communication with a first antenna configured to receive a first plurality of satellite signals at a first position; and a second receiver in operable communication with a second antenna configured to receive a second plurality of satellite signals at a second position; and at least one of the first receiver and the second receiver computing a position corresponding to a position of the second antenna based on at least one of code phase and carrier phase differencing techniques. At least one of: a clock used in the first receiver and a clock used in the second receiver are synchronized to eliminate clock variation between the first receiver and the second receiver, and the first receiver and the second receiver share a common clock.

Further, disclosed herein in yet another exemplary embodiment is a system for measuring relative position of fixed or slow-moving points in close proximity comprising: a means for receiving a set of satellite signals with a first receiver corresponding to a first position; a means for receiving a related set of satellite signals with a second receiver corresponding to a second position; and a means for computing a position of the second position based on at least one of code phase and carrier phase differencing techniques. At least one of: a clock used in the first receiver and a clock used in the second receiver are synchronized to eliminate clock variation between the first receiver and the second receiver, and the first receiver and the second receiver share a common clock.

Also disclosed herein in yet another exemplary embodiment is a storage medium encoded with a machine-readable computer program code, the code including instructions for causing a computer to implement the abovementioned method for measuring relative position of fixed or slow-moving points in close proximity.

Further disclosed herein in yet another exemplary embodiment is a computer data signal, the computer data signal comprising code configured to cause a processor to implement the abovementioned method for measuring relative position of fixed or slow-moving points in close proximity.

### BRIEF DESCRIPTION OF THE DRAWINGS

Referring now to the drawings wherein like elements are numbered alike in the several FIGURES:

FIG. 1 is a block diagram showing the multiple antennas connected via switches to the slave receiver and the single master receiver within the same enclosure to permit clock synchronization;

FIG. 2 is a diagram depicting signals received from multiple satellites at two antenna locations.

### DETAILED DESCRIPTION

This invention discloses the use of two receivers, which either share the same clock, or have a clock synchronization technique to eliminate the receiver clock errors. Further the reference receiver (herein called the master) is connected to a single antenna whereas the slave receiver, which is clock synchronized with the master, has a multitude of antennas connected which are switched in and out to take a measurement at each antenna location.

The GPS rover receiver computes the location vector from a double or single difference of the GPS rover and reference carrier phases for a plurality of GPS satellites. As the receivers are either co-located or have a link, the raw measurement from the slave antennas are sent to the master for computation (of course any receiver or even a separate computer could perform this computation). This eliminates the need for a radio link between the master and slave receivers as is required in prior art RTK.

According to a more specific aspect of the present invention, in order to solve the integer ambiguity problem, the master selects the slave antenna to be measured based on the GPS satellite almanac to provide the best geometry (or one of the best) and based on its time slot. The master also has the slave antenna's position stored to provide an immediate calculation of the carrier cycle ambiguity to each satellite. Position calculation then follows conventional RTK GPS practice of using single or double difference equations involving the total phase distance to each satellite to solve the relative location of slave antenna with respect to the master antenna. As previously described, there is no clock difference between the two receivers (or the clock difference is known and nearly constant) so double differencing may not be required. There may however be a significant delay through the coaxial cable to each slave antenna. This also can be stored and the delay removed to the measurements. A temperature drift may be noticed which will gradually change the delay, but this too can be eliminated by the addition of a thermocouple to determine the ambient temperature around the cable and antennas. By doing this, all satellite measurements may be used in the solution.

Another advantage of eliminating double differencing is that ambiguity search routines will not have to form linear combinations to decorrelate the measurement data. When it is possible to use single differences, they are generally preferred over double differences equations. The double difference cross-correlations are more difficult to deal with mathematically, say in a measurement covariance matrix of a Kalman filter. Single difference equations result in a measurement covariance matrix having zero cross correlation. (But note that if the mathematics is handled correctly the accuracy of both approaches is the same, it is just that the single difference is easier to handle correctly)

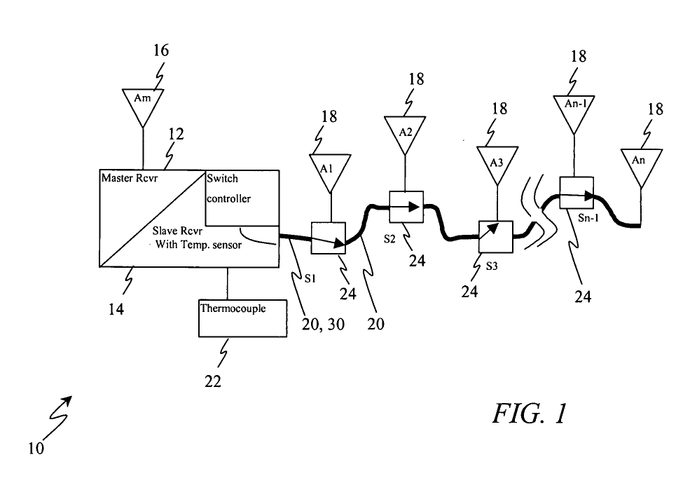

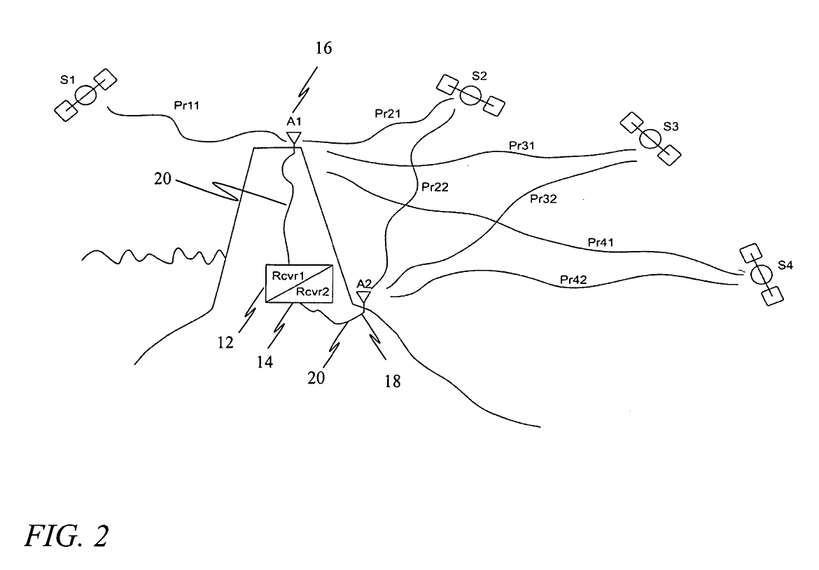

Referring now to FIGS. 1 and 2, a simplified block diagram of the system 10 is depicted. In an exemplary embodiment, a method and system to use of two receivers, which either share the same clock, or include a clock synchronization technique to eliminate the receiver clock errors is disclosed. Further the reference receiver (hereinafter also called the master) 12 is connected to a master antenna, whereas the rover or slave receiver 14, which is clock synchronized with the master, has a multitude of antennas 18 connected which are switched in and out to take a measurement at each antenna location. In addition, the mater receiver 12 and slave receiver 14 may include direct connection for wireless communication to facilitate communication between them. It will be appreciated that while an exemplary embodiment is described and illustrated with respect to measuring movement of a dam, dike or beam. The disclosed invention is readily applicable to other applications where fixed or slow moving phenomena are tracked. Such applications may include roadways bridges, building motion, glacier and iceberg travels and the like. It is also applicable to conventional RTK applications that require relatively short distance between master and slave and where it is desirable to take advantage of a common clock for added robustness and the elimination of a radio for cost and robustenss. For example, one application is local surveying or measuring distance at a construction site, or leveling (such as required for foundation placement) at that site.

In an exemplary embodiment a master receiver 12 also referred to as a reference receiver, and a slave receiver 14, also referred to as a rover or remote receiver are substantially collocated. The master and slave receivers 12 and 14 respectively, are configured to either share the same clock, or include a clock synchronization system. This technique facilitates elimination of the receiver clock errors. In an exemplary embodiment, the GPS slave receiver 14 computes a location vector based on a double or single difference of the GPS code and/or carrier phases for both the master receiver 12 and slave receiver 14 and for a plurality of GPS satellites. As the master and slave receivers 12, and 14 are either co-located or have a link, the raw measurements from the slave antennas are sent to the master for computation (of course any receiver or even a separate computer could perform this computation). This eliminates the need for a radio link between the master and slave receivers 12, 14 as is required in existing RTK applications. Moreover, in another exemplary embodiment, satellite signals from multiple antennas with a known dimensional separation may be combined to achieve receiving an optimal set of satellite signals for a given location. Such an approach will be beneficial for instances when insufficient data is available from a single antenna or less desirable set of satellite signals are all that is available. In this way, a location may still be computed despite poor satellite geometer, obstructions, and the like.

Advantageously, in an exemplary embodiment, rather than increasing the number of measurements, a reduction in the number of unknowns is achieved by eliminating the clock errors between the reference receiver 12 and the rover 14 (or master and slave). This approach yields an even greater advantage than adding measurements, unless a substantial number of measurements could readily be added. In addition, an exemplary embodiment as disclosed herein significantly improves the ability to calculate the integer ambiguities to each satellite. In will be appreciated that because the slave antennas 18 are presumed to move far less than a fraction of a carrier cycle (e.g., 19 cm) between measurements, the positions of each slave antenna 18 location may be stored and then later retrieved as needed to facilitate the immediate calculation of the integer ambiguities.

In order to solve the integer ambiguity problem with current RTK applications, the master receiver 12 selects a particular slave antenna 18 to be measured based on the GPS satellite almanac to provide the best geometry (or one of the best) and based on its time slot. The master receiver 12 also has the slave antenna's position stored (as stated above) to provide an immediate calculation of the carrier cycle ambiguity to each satellite. Position calculation then follows RTK GPS practice of using single or double difference equations involving the total phase distance to each satellite to solve the relative location of slave antenna 18 with respect to the master antenna 16. One such methodology for GPS positioning employing RTK is taught by Whitehead, U.S. Pat. No. 6,469,663 the contents of which are incorporated by reference herein in their entirety. As previously described, there is no clock difference between the two receivers 12 and 14 (or the clock difference is known and nearly constant) so double differencing may not be required. It will however, be readily appreciated that there may be a significant delay through the coaxial cable 20 to each slave antenna 18. This delay is dependent upon the selected position for each antenna relative to the master (e.g., the length of cable to reach each antenna). Advantageously, the delay may readily be measured and stored and the delay mathematically removed to correct the measurements. Moreover, selected antennas may exhibit a temperature drift the may result in a gradual change of the expected delay. However, advantageously, this too may be readily eliminated by the addition of a temperature sensor 22 e.g., thermocouple and the like, to determine the ambient temperature around the cable 20 and antennas e.g., 16 and 18. Advantageously, by employing the abovementioned correction and compensation schemes, all satellite measurements may be used to formulate the solution.

Another advantage of eliminating double differencing is that ambiguity search routines will not have to form linear combinations to decorrelate the measurement data. When it is possible to use single differences, they are generally preferred over double differences equations. The double difference cross-correlations are more difficult to deal with mathematically, say in a measurement covariance matrix of a Kalman filter. Single difference equations result in a measurement covariance matrix with zero cross correlation, which facilitates computation of the ambiguities. It should of course be noted, that if the mathematics is handled correctly, the accuracy of both approaches is the same. However, utilizing the single difference is an easier process.

In yet another exemplary embodiment as an enhancement to the abovementioned embodiments, is the capability to take advantage of the slow dynamics of antenna motion by averaging over periods of time thereby reducing multipath contributions (which are time varying) and poor satellite geometries. In fact, it will be appreciated that the master receiver 12 is constantly tracking the satellites may further be employed select the best time of day e.g., constellation (the GPS satellites orbit in a 12 hour cycle) to perform the measurements based on its knowledge of the slave antennas 18 position and the satellites currently visible. Additionally the master receiver 12 may select two separate times of day, to provide two independent satellite positions for performing the measurements. This would reduce the amount of averaging time required, yet still provide the multipath and poor satellite geometry reduction benefits. Overall, such an approach may be employed reduce power consumption requirements as the receiver would not have to be averaging continuously for a twelve hour period. Power consumption reduction is always beneficial especially at remote sites.

Referring once again to FIG. 1, an exemplary embodiment is shown using a plurality of slave antennas 18 (also denoted as A1, A2 . . . An) connected to the slave receiver 14. Each slave antenna 18 is switched (except the last one in which when all switches are connected through it is selected) with a switch box 24 (also denoted as S1, S2 . . . ). The switch(es) 24 are selected by a controller (in an exemplary embodiment, part of the master receiver 12, which may send a tone or some other control signal 30 on the cable 20 to activate a particular desired switch 24 and thereby the slave antenna 18 connected there to. It will be appreciated that in order to provide fault protection, the switch(es) 24 may be designed and configured so that in the event a switch 24 fails, the connection through to the next switch 24 is made. Advantageously, in this way, if one switch 24 should fail, it will still permit measurements on the remaining slave antennas 18. As is shown in the figure, in one exemplary embodiment, both the master and the slave receivers 12 and 14 respectively, are integrated on a single printed circuit board (PCB), permitting the master and slave receivers to share a common clock. Moreover, in an exemplary embodiment, smart reset circuitry is employed to ensure that they (the master receiver 12 and slave receiver 14) will start up at exactly the same time and therefore the samples will be aligned as well. This approach substantially eliminates the receiver clock biases.

As mentioned previously, phase drift and delay can result from the coaxial cables, which may be removed and/or compensated by using a temperature sensor 22 e.g., a thermocouple to measure the temperature. A look-up table may be employed that has stored (alternately a simple formula may be used to save memory) phase delay difference versus ambient temperature. An alternative embodiment could use equivalent coaxial cable lengths to all antennas including the master so any temperature or other loss and drift effects would be matched and therefore cancelled in the single difference calculation.

Normally in order to solve for integer ambiguities from and GPS satellite signals, double differencing is used to bring forth the integer nature of the ambiguities by removing other non-integer sources of error such as clock and atmospheric delays from the measurements. To illustrate, consider four equations describing pseudo-ranges resulting from measurements of carrier phase on receivers denoted m and n for the slave and master, respectively:

φₘⁱ=Rₘⁱ+τsvⁱ+Aⁱ+Bₘ+Nₘⁱ

φₙⁱ=Rₙⁱ+τsvⁱ+Aⁱ+Bₙ+Nₙⁱ

φₘ^{k}=Rₘ^{k}+τsv^{k}+A^{k}+Bₘ+Nₘ^{k}

φₙ^{k}=Rₙ^{k}+τsv^{k}+A^{k}+Bₙ+Nₙ^{k} i.

Here φₘⁱ is the measured pseudorange from rover receiver m to satellite i, φₙⁱ is the measured pseudorange from reference receiver n to satellite i, φₘ^{k} is the measured pseudorange from rover receiver m to satellite k, and φₙ^{k} is the measured pseudorange from reference receiver n to satellite k. Each pseudorange is actually a measure of the summation a number of different physical quantities all of which shall be expressed in units of carrier cycles at L1 (roughly 19 cm).

Specifically, in the first of these equations, the term Rₘⁱ is the true geometric range from receiver m to satellite i, τsvⁱ is the clock error of satellite i, Aⁱ is the atmospheric delays, which are associated with satellite i, Bₘ is the clock error of receiver m, and Nₘⁱ is the integer ambiguity in the range measurement from receiver m to satellite i. Similar notation applies to the remaining three equations. For simplicity, these equations do not show noise effects such as errors caused by receiver thermal noise or multipath noise.

Consider first applying the single difference. If the first two equations are differenced:

φₘⁱ−φₙⁱ=Rₘⁱ−Rₙⁱ+Bₘ−Bₙ+Nₘⁱ−Nₙⁱ i.

Similarly, differencing the second two equations yields: ii.

φₘ^{k}−φₙ^{k}=Rₘ^{k}−Rₙ^{k}+Bₘ−Bₙ+Nₘ^{k}−Nₙ ^{k} iii.

The satellite common errors, such as satellite clock, τsvⁱ and atmosphere, Aⁱ (atmosphere is common if we assume relative close proximity of receivers m and n) are removed in the single difference. As the clock errors Bₘ are common these term will also cancel out, leaving:

φₘⁱ−φₙⁱ=Rₘⁱ−Rₙⁱ+Nₘⁱ−Nₙⁱ

Since the ambiguities are all integers that can be lumped together into a single term, it may be written:

φₘⁱ−φₙⁱ=Rₘⁱ−Rₙⁱ+Nₘₙ

where

Nₘₙ=NₘⁱNₙⁱ

This shows that single differencing the pseudorange measurements removes common atmospheric errors from the equations while leaving simple combinations of the geometric ranges and integer ambiguities, and clock errors drops out due to the synchronization of the two receivers. For N satellites in common view of the master (reference) and slave (remote) receivers 12 and 14 respectively, there are N such single-difference equations that can be formed without causing mathematical redundancy. Whereas double differencing, to eliminate clock biases in receivers, which are not clock synchronous, results in only N−1 equations. This gives rise to N unknown integer ambiguities that must be solved in addition to the 3 unknown coordinates (X,Y,Z) of the GPS receiver. Note that each geometric range term, for example Rₘⁱ, is a function only of the receiver's position and the transmitting satellite's position. Specifically:

Rₘ^{i=\sqrt{(Xrecvₘ−Xsatⁱ)²+(Yrecvₘ₋Ysatⁱ)²+(Zrecvₘ −Zsat¹)²}}

where Xrecvₘ, YrecvₘZrecvₘ are the Cartesian coordinates of the receiver m at the time reception of the signal from satellite i, whose coordinates are Xsatⁱ, Ysatⁱ, Zsatⁱ at the time of signal transmission. In the problem at hand, only the selected slave's antenna's 18 position is unknown. Once the ambiguities are determined, only the selected antenna's 3-coordinates of position are unknown and these are easily solved using a mathematical approach such as Least Squares.

Every time a new slave antenna 18 is selected, the integer ambiguities must be solved. This is a complex process and can be very time consuming if the position is unknown. However, in this instance, it will be appreciated that the movements to be measured are on the order of less than a quarter of a wavelength (5 cm) between measurements. This limitation permits a rapid calculation of the integer ambiguities since the master receiver 12 “knows” the satellite's position and the selected antenna's position well enough to directly calculate ambiguities. Such an approach will greatly reduce the time utilized to solve for the integer from up to 10 minutes to a second or less. Cycle slips, which result usually from motion which the receiver failed to track properly and therefore slipped from one ambiguity to another is also greatly reduced due to the very low dynamics of the selected antenna location. An added benefit of the low dynamics is the receiver can integrate the measurements over a long period of time and narrow the carrier tracking loop bandwidth to reduce noise.

As mentioned previously, it should be appreciated that another source of error in applying RTK positioning, especially when solving for integer ambiguities over long baselines, is non-common atmospheric propagation delays on the signals received by the slave (rover) 14 and master (reference) receivers 12. Since differencing cannot eliminate these non-common delays, the next best alternative is to estimate or model their effects. However, In an exemplary embodiment, the slave antennas 18 and the master antenna 16 will, most likely, be within 5 kilometers of each other and at this distance the atmospheric effects are minimal and may readily be ignored.

A further advantage of this technique should permit a carrier phase based solution even when a large portion of the sky, and therefore the visible satellites, are obscured by a wall, dam or other structure. This is because, as described above, the receiver will still have one more measurement than previously due to the utilization of single differencing rather than double differencing technique. In addition, the fixed or very slow moving nature of the problem permits long-term measurements.

Referring now to FIG. 2 as well, in yet another exemplary embodiment, a technique is employed to utilize and take advantage of the master receiver's 12 knowledge of the satellite's location in the sky, and a preprogrammed knowledge of the visibility of the sky for selected slave antennas 18. The master receiver 12 may then chose the best time, that is, the time with the most satellites visible to the selected slave antenna 18, to perform the measurement at that location. The receiver can then dwell for some time (say one half hour) to integrate and reduce noise, then move on to another slave antenna 18. Moreover, it will be appreciated that the master receiver 12 may direct that the slave receiver return to the same location after some duration e.g. a few hours, when another optimal/desirable geometry is available, which is uncorrelated to the first. By taking measurements at two (or more) different times (and geometries), and averaging the two (or more) measurements, multipath and atmospheric induced errors, typically correlated over time, will be reduced. This method will allow monitoring of the face of a dam or berm, or even a valley wall, which was previously impossible to monitor.

Further assumptions may be made of the anticipated motion of the monitoring point at the selected slave antenna 18 to further reduce the number of measurements required.

For example, if it is a dam, the anticipated motion is horizontally away from the pressure excerpted by the material behind the dam. By performing the calculation only on this direction, a single satellite may be enough to perform a measurement. This is obvious when looking at this equation:

Rₘ^{i=\sqrt{(Xrecvₘ−Xsatⁱ)²+(Yrecvₘ−Ysatⁱ)²+(Zrecvₘ−Zsatⁱ)²}}

As explained previously the satellite position (Xsat, Ysat and Zsat) are known, and if the receiver assumes there is minimal motion in Y and Z then there is only one unknown left. Of course, additional satellites are highly desired to reduce noise and errors and to help detect any false or erroneous readings from throwing the solution off.

Another area of concern for running a long length of coaxial cable to the antennas other than phase delay, which was addressed earlier, is attenuation. In yet another exemplary embodiment, the slave antennas 18 may be configured as active antennas, e.g., antennas that include an internal Low Noise Amplifier (LNA). In a receiver design, Noise Figure is often important, Noise Figure is a combination of the noise temperature before the first LNA, the LNA noise figure, then subsequent losses divided by the LNA gain. Subsequent amplifier's gains will reduce following noise temperature (T) contributions by their gain as is shown in the equation below:

Tt=T(pre LNA)+T(LNA)+T(lna2)/(CL×Glna1) +T(lna3)/(CL×Glna1×Glna2)+T(lna4)/(CL×Glna1×Glna2×Glna3) etc.

where: CL refers to cable losses in linear terms, that is −10 dB is 0.1,

Glnan refers to gain of LNAn in linear terms so a gain of 20 dB is 100,

T(LNAn) refers to the noise temperature in Kelvin of stage n.

Noise Figure (F) is related to noise temperature by:

F(dB)=10×LOG((1+T)/Tamb)

Where Tamb refers to the reference temperature, typically 290 K (20 Celsius).

As an example, a typical low loss coaxial cable (RG6 type) has 20 dB (CL=0.01) of attenuation every 100 meters. The noise temperature of the antenna and LNA is 170 K (2 dB noise figure), the gain of the first LNA is 30 dB (or 1000). Subsequent LNA's have the same noise temperature and a gain of 12 dB (15.8). If each antenna is 50 meters apart the losses are −10 dB. After five stages the noise temperature of the system is:

T5=T1+T2/(CL1×G1)+T3/(CL1×C12×G1×G2)+T4/(CL1×CL2×C13×G1×G2×G3)+T5/(CL1×C12×C13×C14×G1×G2×G3×G4)

T5=190+190/100+190/158+190/250+190/395

T5=194 K

F5=2.22 dB

This is compared to the first stage, which would have a noise figure of 2 dB. A GPS receiver such as the master receiver 12, or slave receiver 14 can operate with a noise figure of up to 3.5 dB without suffering significant degradation. As can be seen, additional stages will have diminishing contributions. The total gain will be increasing by only 2 dB each step, so after 1 km, in this example, the maximum gain will be 68 dB, the gain of the first stage is 30 dB, the Automatic Gain Control of the receiver can remove this difference easily. Also after 20 stages (1 km) the total noise temperature in this example would be T(1 km)=194.7 K, an insignificant increase.

Further, in another exemplary embodiment, multiple antennas could be used to compute a solution of a single point on a rigid body to which they are attached, using known geometry and distances. Such an approach may be employed, for example, when not any one antenna provides enough useful information (satellites) to compute a location solution due to obstructions, but the conglomerate could. Advantageously, a position solution employing this approach would not necessarily have to utilize carrier-phase based differencing (it could be code phase). An application might include positioning on a barge, where location is needed but there are many cranes and towers blocking the view so that there is not one optimum GPS location. However, by placing an antenna on either side of the barge, enough satellites could be tracked by the combined antenna arrangement that a solution of the location of some point on the barge could still be obtained. Furthermore, on a barge, a compass could also be used to give orientation, thus removing another unknown from the relative location of the two receivers. Rather than solving a relative location of one receiver with respect to another, using the combined receivers to produce one non-relative location.

It will be appreciated that the satellite systems as discussed herein may include but not be limited to Wide Area Augmentation System (WAAS), Global Navigation Satellite System (GNSS) including GPS, GLONASS and other satellite ranging technologies. The term WAAS here is used as a generic reference to all GNSS augmentation systems which, to date, include three programs: WAAS (Wide Area Augmentation System) in the USA, EGNOS (European Geostationary Navigation Overlay System) in Europe and MSAS (Multifunctional Transport Satellite Space-based Augmentation System) in Japan. Each of these three systems, which are all compatible, consists of a ground network for observing the GPS constellation, and one or more geostationary satellites.

It will be appreciates that while a particular series of steps or procedures is described as part of the abovementioned process, no order of steps should necessarily be inferred from the order of presentation. For example, the process includes receiving one or more sets of satellite signals. It should be evident the order of receiving the satellite signals is variable and could be reversed without impacting the methodology disclosed herein or the scope of the claims.

It should further be appreciated that while an exemplary partitioning functionality has been provided. It should be apparent to one skilled in the art, that the partitioning could be different. For example, the control of the master receiver 12 and slave receiver 14, could be integrated in any, or another unit. The processes may, for ease of implementation, be integrated into a single unit. Such configuration variances should be considered equivalent and within the scope of the disclosure and claims herein.

The disclosed invention may be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or as data signal transmitted whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the description has been made with reference to exemplary embodiments, it will be understood by those of ordinary skill in the pertinent art that various changes may be made and equivalents may be substituted for the elements thereof without departing from the scope of the disclosure. In addition, numerous modifications may be made to adapt the teachings of the disclosure to a particular object or situation without departing from the essential scope thereof. Therefore, it is intended that the Claims not be limited to the particular embodiments disclosed as the currently preferred best modes contemplated for carrying out the teachings herein, but that the Claims shall cover all embodiments falling within the true scope and spirit of the disclosure.

What is claimed is:

1. A method for measuring relative position of fixed or slow-moving points in close proximity comprising:
receiving a set of satellite signals with a first receiver corresponding to a first position;
receiving a related set of satellite signals with a second receiver corresponding to a second position;
computing a position of said second position based on at least one of code phase and carrier phase differencing techniques wherein at least one of:
a clock used in said first receiver and a clock used in said second receiver are synchronized to eliminate clock variation between said first receiver and said second receiver, and
said first receiver and said second receiver share a common clock.

2. The method of claim 1 further including:
receiving a third set of satellite signals with said slave receiver from an antenna corresponding to a third position; and
computing a position of said third position based on at least one of code phase and carrier phase differencing techniques wherein at least one of:
a clock used in said first receiver and a clock used in said second receiver are synchronized to eliminate clock variation between said first receiver and said second receiver, and
said first receiver and said second receiver share a common clock.

3. The method of claim 2 further including switching from said related set of satellite signals to said third set of satellite signals.

4. The method of claim 1 wherein said carrier phase differencing include Real Time Kinematic (RTK) solutions.

5. The method of claim 1 wherein said first receiver and said second receiver are positioned within sufficient proximity to facilitate wired communication between said first receiver and said second receiver.

6. The method of claim 1 further including combining satellite signals from at least two of said first antenna said second antenna, said third antenna, and another antenna to form at least one of said set of satellite signals and said related set of satellite signals, said at least two of said first antenna said second antenna, said third antenna, and another antenna exhibiting a known relative geometry.

7. The method of claim 1 wherein said receiving a related set of satellite signals occurs at a time selected by said first receiver, said time selected to achieve receiving an optimal set of satellite signals available based on satellite geometry.

8. The method of claim 1 further including configuring said first receiver as a master and said second receiver as a slave.

9. A system for measuring relative position of fixed or slow-moving points in close proximity comprising:
a first receiver in operable communication with a first antenna configured to receive a first plurality of satellite signals at a first position;
a second receiver in operable communication with a second antenna configured to receive a second plurality of satellite signals at a second position;
at least one of said first receiver and said second receiver computing a position corresponding to a position of said second antenna based on at least one of code phase and carrier phase differencing techniques wherein at least one of:
a clock used in said first receiver and a clock used in said second receiver are synchronized to eliminate clock variation between said first receiver and said second receiver, and
said first receiver and said second receiver share a common clock.

10. The system of claim 9 further including:
a third antenna configured to receive a third set of satellite signals at a third position; and
at least one of said first receiver and said second receiver computing a position of said third position based on at least one of code phase and carrier phase differencing techniques wherein at least one of:
a clock used in said first receiver and a clock used in said second receiver are synchronized to eliminate clock variation between said first receiver and said second receiver, and
said first receiver and said second receiver share a common clock.

11. The system of claim 9 further including a switching device in operable communication with said second receiver configured to facilitate switching from said second set of satellite signals to a third set of satellite signals.

12. The system of claim 9 wherein said carrier phase differencing include Real Time Kinematic (RTK) solutions.

13. The system of claim 9 wherein said first receiver and said second receiver are positioned within sufficient proximity to facilitate wired communication between said first receiver and said second receiver.

14. The system of claim 9 further including combining satellite signals from at least two of said first antenna said second antenna, said third antenna, and another antenna to form at least one of said set of satellite signals and said related set of satellite signals, said at least two of said first antenna said second antenna, said third antenna, and another antenna exhibiting a known relative geometry.

15. The system of claim 9 wherein said related set of satellite signals is received at a time selected by said first receiver, said time selected to achieve receiving an optimal set of satellite signals available based on satellite geometry.

16. The system of claim 9 wherein said first receiver is a master and said second receiver is a slave.

17. A system for measuring relative position of fixed or slow-moving points in close proximity comprising:
a means for receiving a set of satellite signals with a first receiver corresponding to a first position;
a means for receiving a related set of satellite signals with a second receiver corresponding to a second position;
a means for computing a position of said second position based on at least one of code phase and carrier phase differencing techniques wherein at least one of:
a clock used in said first receiver and a clock used in said second receiver are synchronized to eliminate clock variation between said first receiver and said second receiver, and
said first receiver and said second receiver share a common clock.

18. A storage medium encoded with a machine-readable computer program code, the code including instructions for causing a computer to implement a method for measuring relative position of fixed or slow-moving points in close proximity, the method comprising:
receiving a set of satellite signals with a first receiver corresponding to a first position;
receiving a related set of satellite signals with a second receiver corresponding to a second position;
computing a position of said second position based on at least one of code phase and carrier phase differencing techniques wherein at least one of:
a clock used in said first receiver and a clock used in said second receiver are synchronized to eliminate clock variation between said first receiver and said second receiver, and
said first receiver and said second receiver share a common clock.

19. A computer data signal, the computer data signal comprising code configured to cause a processor to implement a method for measuring relative position of fixed or slow-moving points in close proximity, the method comprising:
receiving a set of satellite signals with a first receiver corresponding to a first position;
receiving a related set of satellite signals with a second receiver corresponding to a second position;
computing a position of said second position based on at least one of code phase and carrier phase differencing techniques wherein at least one of:
a clock used in said first receiver and a clock used in said second receiver are synchronized to eliminate clock variation between said first receiver and said second receiver, and
said first receiver and said second receiver share a common clock.
